(19) United States
(12) Patent Application Publication
(10) Pub. No.: US 2020/0036765 A1
(43) Pub. Date: Jan. 30, 2020

(54) METHOD AND DEVICE FOR TRANSMITTING CONTENT

(71) Applicant: Samsung Electronics Co., Ltd., Gyeonggi-do (KR)

(72) Inventors: Min-Gyu LEE, Gyeonggi-do (KR); Se-Hee HAN, Seoul (KR)

(21) Appl. No.: 15/740,963

(22) PCT Filed: Oct. 10, 2017
(86) PCT No.: PCT/KR2017/011140

§ 371 Date: Dec. 29, 2017

Related U.S. Application Data
(60) Provisional application No. 62/408,161, filed on Oct. 14, 2016.

(51) Int. Cl. H04L 29/06; H04L 29/08

(52) U.S. Cl. CPC H04L 65/608; H04L 67/12; H04L 65/1069

(57) ABSTRACT

The present disclosure relates to a method and a device for transmitting content to a display device. The content transmission method includes: receiving a display type from a sink device; generating content in view of the display type; and transmitting the generated content to the sink device, wherein the display type includes information indicating a set type of a display of the sink device.

### TECHNICAL FIELD

The present disclosure relates to a method and a device for transmitting content in a Machine-to-Machine (M2M) network.

### BACKGROUND ART

Generally, Internet of Things (IoT) services are implemented based on short-range communication technologies in a Machine-to-Machine (M2M) network. A Miracast service is one example of an IoT service that is performed based on short-range communication technologies.

The Miracast service enables content output through a display of a particular electronic device to be output the same through a display of another electronic device based on a short-range communication technology, for example, Wi-Fi.

For example, the Miracast service enables content output through a display of a smartphone to be provided the same through a display of a smart TV, a smart refrigerator, or the like.

### DETAILED DESCRIPTION OF THE INVENTION

### Technical Problem

Generally, the form and the type of a display in an electronic device may be determined in view of offered functions. For example, it may be desirable to dispose a display in a portrait mode in an electronic device, such as a refrigerator, while it may be desirable to dispose a display in a landscape mode in an electronic device, such as a smart TV.

Thus, when a Miracast service is provided for electronic devices having different shapes of displays, it may be desirable that one electronic device providing content provides content in an appropriate form for the shape of a display installed in a counterpart electronic device.

Various embodiments of the present disclosure may provide a device and a method enabling a source device to provide content information in view of the display type of a sink device.

The present disclosure provides a method and a device enabling a source device to transmit content corresponding to the display type of a sink device even though the sink device does not rotate the content.

The present disclosure provides a method and a device enabling a source device to transmit content corresponding to the display type of a sink device so that the sink device does not need to rotate the received content corresponding to the display type, thereby preventing the flicker of the screen by rotation in the sink device.

### Technical Solution

According to one embodiment of the present disclosure, a method for transmitting, by a source device, content to a sink device includes: receiving a display type from the sink device; generating content in view of the display type; and transmitting the generated content to the sink device, wherein the display type includes information indicating a set type of a display of the sink device.

According to one embodiment of the present disclosure, a method for receiving, by a sink device, content from a source device includes: transmitting a display type to the source device; receiving content in view of the display type from the source device; and outputting the content through a display, wherein the display type includes information indicating a set type of the display of the sink device.

According to one embodiment of the present disclosure, a source device for transmitting content to a sink device includes: a transceiver that receives a display type from the sink device and transmits content to the sink device; and a processor that generates content in view of the display type and controls the transceiver to transmit the generated content to the sink device, wherein the display type includes information indicating a set type of a display of the sink device.

According to one embodiment of the present disclosure, a sink device for receiving content from a source device includes: a display; a transceiver that transmits a display type to the source device and receives content in view of the display type from the source device; and a processor that controls the display to output the content, wherein the display type includes information indicating a set type of a display of the sink device.

### BRIEF DESCRIPTION OF DRAWINGS

The above and other aspects, features and advantages of exemplary embodiments of the present disclosure will be more apparent from the following detailed description taken in conjunction with the accompanying drawings, in which:

FIG. 1A illustrates a content transmission procedure according to Miracast;

FIG. 1B illustrates a message transmission procedure according to Miracast;

FIG. 1C illustrates content output from a display of a source device and content output from a display of a sink device by a content transmission procedure according to Miracast;

FIG. 2 illustrates a method for transmitting content including resolution information according to the Miracast R1 standard;

FIG. 3 illustrates a method for transmitting content including portrait mode information according to the Miracast R2 standard;

FIG. 4 illustrates a message transmission procedure for providing content to a sink device having a portrait-type display according to a first embodiment of the present disclosure;

FIG. 5 illustrates a message transmission procedure for providing content to a sink device having a portrait-type display according to a second embodiment of the present disclosure;

FIG. 6 illustrates content output from a display of a sink device according to the first embodiment and the second embodiment of the present disclosure;

FIG. 7 illustrates a mode of transmitting content to a sink device having a portrait-type display according to a third embodiment of the present disclosure;

FIG. 8A illustrates a message transmission procedure for providing content to a sink device having a portrait-type display according to option 1 of the third embodiment of the present disclosure;

FIG. 8B illustrates a message transmission procedure for providing content to a sink device having a portrait-type display according to option 2 of the third embodiment of the present disclosure;

FIG. 9 illustrates a mode of transmitting content to a sink device having a portrait-type display according to a fourth embodiment of the present disclosure;

FIG. 10 illustrates a message transmission procedure for providing content to a sink device having a portrait-type display according to a fourth embodiment of the present disclosure;

FIG. 11 illustrates a table of resolution parameters according to the fourth embodiment of the present disclosure;

FIG. 12 illustrates a method for transmitting content to a sink device having a portrait-type display according to the first embodiment of the present disclosure;

FIG. 13 illustrates a method for transmitting content to a sink device having a portrait-type display according to the second embodiment of the present disclosure;

FIG. 14 illustrates a method for transmitting content to a sink device having a portrait-type display according to the third embodiment of the present disclosure;

FIG. 15 illustrates a method for transmitting content to a sink device having a portrait-type display according to the fourth embodiment of the present disclosure;

FIG. 16 illustrates the configuration of a source device according to one embodiment of the present disclosure; and

FIG. 17 illustrates the configuration of a sink device according to one embodiment of the present disclosure.

It should be noted that like reference numerals are used to illustrate equivalent or like elements, features, and structures throughout the drawings.

### MODE FOR CARRYING OUT THE INVENTION

Hereinafter, embodiments of the present disclosure will be described in detail with reference to the accompanying drawings.

In describing the embodiments of the present disclosure, a description of technical details well known in the art to which the present disclosure pertains and not directly associated with the present disclosure will be omitted. This omission of the unnecessary description is intended to prevent the main idea of the present disclosure from being unclear and more clearly transfer the main idea.

For the same reason, in the accompanying drawings, some elements may be exaggerated, omitted, or schematically illustrated. Further, the size of each element does not entirely reflect the actual size. In the drawings, identical or corresponding elements are provided with identical reference numerals.

The advantages and features of the present disclosure and ways to achieve them will be apparent by making reference to embodiments as described below in detail in conjunction with the accompanying drawings. However, the present disclosure is not limited to the embodiments set forth below, but may be implemented in various different forms. The following embodiments are provided only to completely disclose the present disclosure and inform those skilled in the art of the scope of the present disclosure, and the present disclosure is defined only by the scope of the appended claims. Throughout the specification, the same or like reference numerals designate the same or like elements.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” can be either combined into a smaller number of elements or “unit”, or further divided into additional elements or “unit”. Moreover, the elements and “units” or “modules” may be implemented to reproduce one or more CPUs within a device or a security multimedia card.

In describing the embodiments of the present disclosure in detail, although a particular wireless communication system will be the primary target, it is to be understood that the subject matter to be claimed herein may be applied to other communication systems and services having similar technical backgrounds without departing from the scope of the disclosure herein, and this will be possible at the discretion of the person skilled in the art.

A first embodiment of the present disclosure proposes a method for transmitting content based on the display type of a sink device included in an M21 request message according to the Miracast standard before streaming the content.

A second embodiment of the present disclosure proposes a method for transmitting content based on the display type of a sink device included in an M21 request message according to the Miracast standard after streaming the content and transmitting the M21 request message including the display type of the sink device.

A third embodiment of the present disclosure proposes a method in which a sink device reports a display type to a source device before session setup and a source device transmits content based on the display type transmitted from the sink device even though the orientation of the content is changed during streaming.

A fourth embodiment of the present disclosure proposes a method for transmitting content based on available resolution by a source device transmitting supportable resolution to a sink device before session setup and by the sink device transmitting the available resolution. Here, the supportable resolution and the available resolution correspond to a display set in a portrait mode.

Accordingly, in the first embodiment, the second embodiment, the third embodiment, and the fourth embodiment of the present disclosure, no renegotiation on performance between the source device and the sink device is needed except that the display type of the sink device is changed, and the source device can stream content corresponding to the portrait-type display even though the sink device does not support a rotation function.

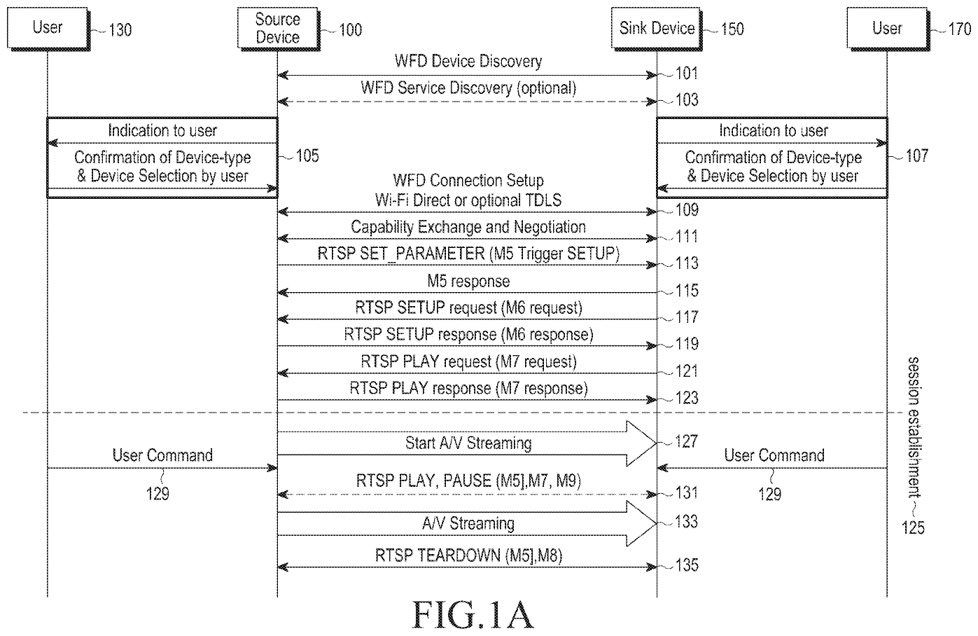

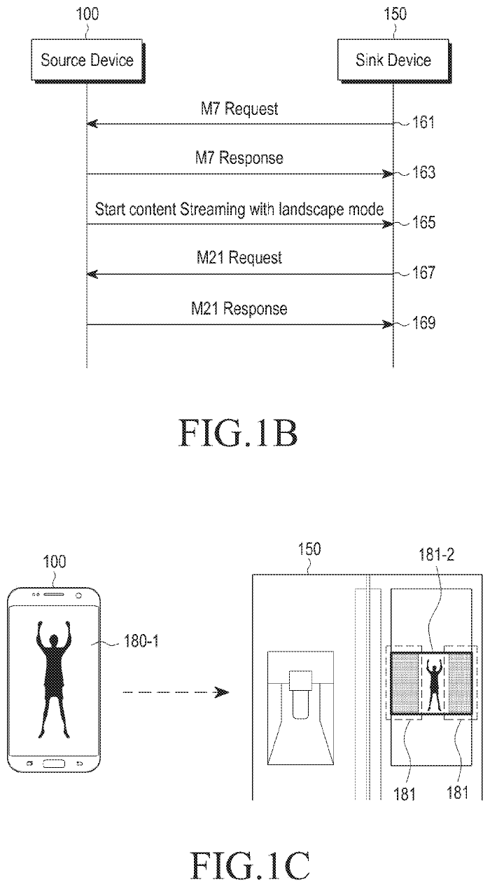

FIG. 1A illustrates a content transmission procedure according to Miracast.

Referring to FIG. 1A, a source device 100, which is a Wi-Fi Display (WFD) device providing content, and a sink device 150, which is a WFD device outputting the same content as the source device, perform the discovery of a WFD device (101). Optionally, the source device 100 and the sink device 150 may perform the discovery of a WFD service (103). The source device 100 may display the result of the device discovery to a user 130 and may receive confirmation of the sink device type and a selection of a device to be connected from the user 130 (105). The sink device 150 may also display the result of the device discovery to a user 170 and may receive confirmation of the source device type and a selection of a device to be connected from the user 170 (107). Accordingly, WFD connection setup is established between the source device 100 and the sink device 150 (109). Specifically, Wi-Fi Direct is established between the source device 100 and the sink device 150, and Wi-Fi Tunneled Direct Link Setup (TDLS) may be optionally established. The source device 100 and the sink device 150 connected to each other exchange the capabilities of content support information or the like, for example, resolution, and negotiate a capability to be applied when outputting content (111). The source device 100 transmits Real-Time Streaming Protocol (RTSP) SET_PARAMETER included in an M5 Trigger SETUP message to the sink device 150 (113), and receives an M5 response message from the sink device 150 (115). Here, the M5 message is used for information exchange for RTSP session setup. The sink device 150 transmits an RTSP setup request via an M6 request message (117) and receives an RTSP setup response from the source device 100 via an M6 response message (119). RTSP session setup is completed via M6 message exchange, which is defined as RTSP session establishment completion in this specification. The sink device 150 transmits an RTSP playback request to the source device 100 through an M7 request message (121) and receives an RTSP playback response through an M7 response message (123). According to a definition by Miracast, the source device 100 and the sink device 150 complete session establishment at the time when the exchange of the M7 messages is completed (125). When the session is established, the source device 100 starts streaming audio/video (A/V) content to the sink device 150 (127). The source device 100 and the sink device 150 may play back or pause the content (131) upon receiving a command from the user 130 or 170 (129). The source device 100 may stream the content to the sink device 150 (133), and the source device 100 and the sink device 150 may terminate the session by exchanging RTSP TEARDOWN messages (135).

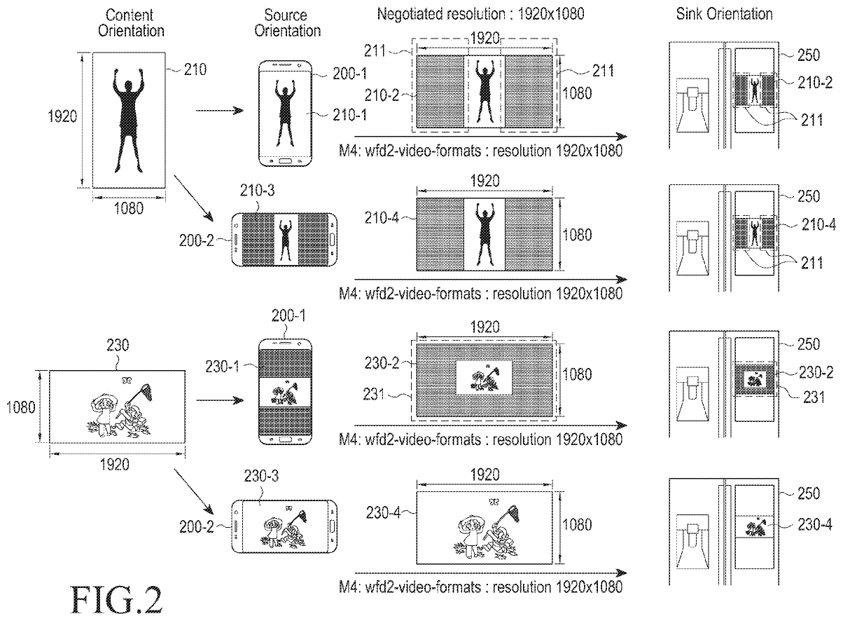

According to the Miracast R1 standard, the source device 100 converts the resolution of content to stream at a landscape-mode resolution corresponding to a landscape-type display and streams the content to the sink device 150. However, when the sink device 150 includes a portrait-type display, the sink device 150 may have a problem in outputting content corresponding to a display of a landscape type. That is, content output from the sink device 150 corresponds to the landscape-mode resolution and thus may be different from the content output from the source device 100. Content output from the sink device 150 and content output from the source device 100 will be described in detail with reference to FIG. 1C. Further, the Miracast R1 standard will be described in detail with reference to FIG. 2.

An M21 message, which indicates to the source device 100 that the sink device 150 includes the portrait-type display, may be transmitted after the session is established (125). That is, since the source device 100 starts streaming the content (127) after the exchange of the M7 messages (121 and 123), when the sink device 150 includes the portrait-type display, there is a problem that the sink device 150 may output content different from the content streamed from the source device 100 before the M21 is transmitted. Here, the M21 message is a message exchanged for the sink device 150 to control video parameters of the source device 100. The sink device 150 transmits a request message for a preferred content form, for example, a video parameter, to the source device 100, and the source device 100 transmits a response to the request to the sink device 150.

FIG. 1B illustrates a message transmission procedure according to Miracast. A procedure before the transmission of an M7 message from the sink device 150 to the source device 100 is omitted.

Referring to FIG. 1B, when the sink device 150 transmits an M7 request message to the source device 100 (161), the source device 100 transmits an M7 response message to the sink device 150 in response thereto (163). When the exchange of the M7 messages is completed, the source device 100 streams content to the sink device 150 in a landscape mode (165). Here, the source device 100 converts the resolution of the streamed content corresponding to a landscape-type display according to the Miracast R1 standard, and streams the content with the converted resolution. The content output from the source device 100 is shown in FIG. 1C. After outputting the content, the sink device 150 may transmit an M21 request message to the source device 100, thereby indicating that the sink device 150 prefers a portrait-type display (167). The source device 100 may transmit an M21 response message to the sink device 150 in response to the received M21 request message (169).

FIG. 1C illustrates content output from a display of a source device and content output from a display of a sink device by a content transmission procedure according to Miracast.

Referring to FIG. 1C, the source device 100 may be a terminal, such as a smartphone, and the sink device 150 may be a smart refrigerator. The sink device 150 may include a portrait-type display.

Content 180-1 may be output from the source device 100 having a portrait-type display. Here, the source device 100 may stream the content 180-1 in the landscape mode to the sink device 150 according to the Miracast R1 standard. The sink device 150 outputs content 180-2 streamed in the landscape mode to the portrait-type display. Here, the content 180-2 output to the portrait-type display may be different from the content 180-1 output from the source device 100. That is, the content 180-1 output from the source device 100 does not include a blank screen in addition to the content 180-1, but the content 180-2 output from the sink device 150 may include a blank screen 181 other than the blank screen 180-2.

Accordingly, when the sink device 150 prefers the portrait-type display, the problem that the sink device 150 outputs the content 180-2 that is different from the content 180-1 provided by the source device 100 needs to be solved.

FIG. 2 illustrates a method for transmitting content including resolution information according to the Miracast R1 standard.

Referring to FIG. 2, a source device may be a terminal 200-1 or 200-2, such as a smartphone, and a sink device may be a smart refrigerator 250. The sink device may include a portrait-type display.

Content 210 set to a resolution of 1080 in width and 1920 in height may be output to a terminal 200-1 having a portrait-type display. Here, since the display of the terminal 200-1 is set to the portrait type, content 210-1 output from the terminal 200-1 may be set to a resolution of 1080 in width and 1920 in height, which is the same as that of the content 210. The terminal 200-1 transmits the content 210-1 to the smart refrigerator 250 according to the Miracast method so that the smart refrigerator 250 also outputs the content 210-1. Here, the terminal 200-1 transmits, to the smart refrigerator 200, content 210-2 with converted resolution corresponding to a landscape-type display according to the Miracast R1 standard. Further, the terminal 200-1 transmits an M4 request message to the smart refrigerator 250 in order to report resolution information on the transmitted content 210-2 to the smart refrigerator 250. The M4 request message includes a wfd2-video-formats parameter including resolution information on content according to the Miracast R1 standard. wfd2-video-formats include a resolution value corresponding to a landscape-type display, for example, a resolution of 1920×1080 that indicates a resolution of 1920 in width and 1080 in height. Here, a resolution of 1920×1080 may be a predetermined value. Accordingly, the smart refrigerator 250 may recognize the resolution of the received content 210-2 based on the wfd2-video-formats parameter in the M4 request message and may output the content to the display. Here, the smart refrigerator 250 includes a portrait-type display. Since the smart refrigerator 250 receives and outputs the content 210-2 with the converted resolution corresponding to the landscape-type display according to the Miracast R1 standard, the content 210-2 may be output in a different form from the content 210-1 output from the terminal 200-1. For reference, the Miracast R1 standard supports resolutions corresponding to a landscape-type display only.

Specifically, the content 210-1 output from the terminal 200-1 does not include a blank screen in addition to the content 210-1, but the content 210-2 with the converted resolution according to the Miracast R1 standard may include left and right blank screens 211 other than the contents 210-2.

The content 210 set to a resolution of 1080 in width and 1920 in height may be output to a terminal 200-2 having a display set to the landscape type. Here, since the display of the terminal 200-2 is set to the landscape type, content 210-3 output from the terminal 200-2 may have different resolution from that of the content 210. For example, the content 210 is set to a resolution of 1080 in width and 1920 in height, but the content 210-3 output from the terminal 200-2 may be set to a resolution of 1920 in width and 1080 in height. The terminal 200-2 transmits the content 210-3 to the smart refrigerator 250 according to the Miracast method so that the smart refrigerator 250 also outputs the content 210-3 output on the landscape-type display. Here, the terminal 200-2 transmits an M4 request message including wfd2-video-formats having a resolution value, for example, a resolution 1920×1080, to the smart refrigerator 250 according to the Miracast R1 standard. Accordingly, the smart refrigerator 250 may output content 210-4 corresponding to the resolution value of the wfd2-video-formats parameter of the M4 request message. Since the content 210-3 output from the landscape-type display of the terminal 200-2 and the content 210-4 output to the smart refrigerator 250 have the same resolution of 1920 in width and 1080 in height, the smart refrigerator 250 may output the content 210-4 in the same form as the content 210-3 output from the terminal 200-2.

Content 230 set to a resolution of 1920 in width and 1080 in height may be output to the terminal 200-1 having the portrait-type display. Here, since the display of the terminal 200-1 is set to the portrait type, content 230-1 output from the terminal 200-1 may have different resolution from that of the content 230. For example, the content 230 is set to a resolution of 1920 in width and 1080 in height, but the content 230-1 output from the terminal 200-1 may be set to a resolution of 1080 in width and 1920 in height. The terminal 200-1 transmits the content 230-1 to the smart refrigerator 250 according to the Miracast method so that the smart refrigerator 250 also outputs the content 230-1 output on the portrait-type display. Here, the terminal 200-1 transmits, to the smart refrigerator 200, content 230-2 with converted resolution corresponding to a landscape-type display according to the Miracast R1 standard. Further, the terminal 200-1 transmits, to the smart refrigerator 250, an M4 request message including wfd2-video-formats parameter having a resolution value corresponding to the landscape-type display, for example, a resolution of 1920×1080, according to the Miracast R1 standard. Accordingly, the smart refrigerator 250 may recognize the resolution of the received content 230-2 based on the wfd2-video-formats parameter in the M4 request message and may output the content to the display. Here, the smart refrigerator 250 includes the portrait-type display. Since the smart refrigerator 250 receives and outputs the content 230-2 with the converted resolution corresponding to the landscape-type display according to the Miracast R1 standard, the content 230-2 may be output in a different form from the content 230-1 output from the terminal 200-1.

Specifically, the content 230-1 output from the terminal 200-1 includes no blank screen on the left and right of the content 230-1, but the content 230-2 with the converted resolution according to the Miracast R1 standard may have blank screens 211 on the left and right of the contents 230-2.

The content 230 set to a resolution of 1920 in width and 1080 in height may be output to the terminal 200-2 having the display set to the landscape type. Here, since the display of the terminal 200-2 is set to the landscape type, content 230-3 output from the terminal 200-2 may be set to a resolution of 1920 in width and 1080 in height, which is the same as that of the content 230. The terminal 200-2 transmits the content 230-3 to the smart refrigerator 250 according to the Miracast method so that the smart refrigerator 250 also outputs the content 230-3 output on the landscape-type display. Here, the terminal 200-2 transmits an M4 request message including wfd2-video-formats having a resolution value, for example, a resolution 1920×1080, to the smart refrigerator 250 according to the Miracast R1 standard. Accordingly, upon receiving the content 230-3 from the terminal 200-2, the smart refrigerator 250 may output content 230-4 corresponding to the resolution value of the wfd2-video-formats parameter of the M4 request message. Since the content 230-3 output from the landscape-type display of the terminal 200-2 and the content 230-4 output to the smart refrigerator 250 have the same resolution of 1920 in width and 1080 in height, the smart refrigerator 250 may output the content 230-4 in the same form as the content 230-3 output from the terminal 200-2.

As described above, since the Miracast R1 standard converts content based on resolution corresponding to a landscape-type display, the smart refrigerator 250 including the portrait-type display may output content different from content output on the terminal 200-1 or 200-2 depending on the display orientation set in the terminal 200-1 or 200-2. That is, the smart refrigerator 250 may display unnecessary blank screens included on the left and right of the content.

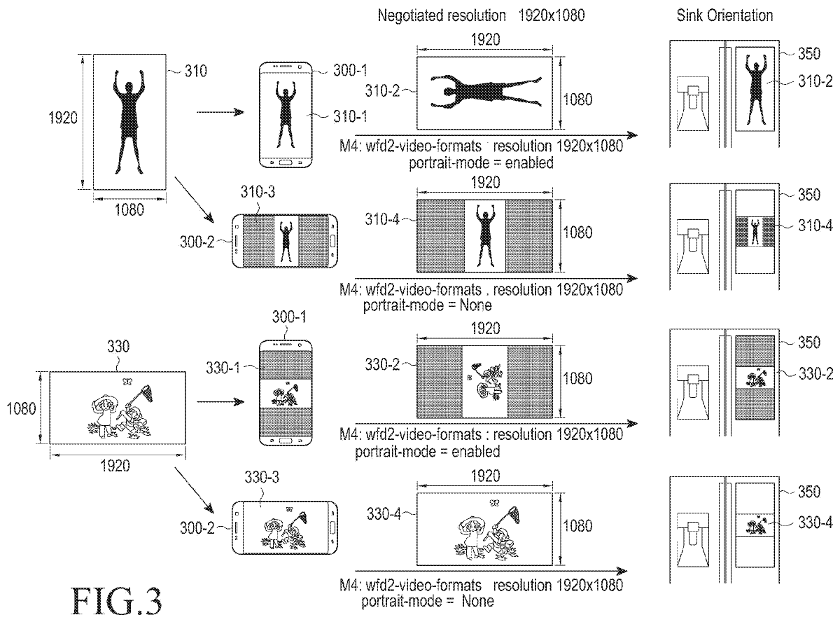

FIG. 3 illustrates a method for transmitting content including portrait mode information according to the Miracast R2 standard.

Referring to FIG. 3, content 310 set to a resolution of 1080 in width and 1920 in height may be output to a terminal 300-1 having a portrait-type display. Here, since the display of the terminal 300-1 is set to the portrait type, content 310-1 output from the terminal 300-1 may be set to a resolution of 1080 in width and 1920 in height, which is the same as that of the content 310. The terminal 300-1 converts the resolution of the content 310-1 corresponding to a landscape-type display according to the Miracast R2 standard and transmits the content to a smart refrigerator 350. Here, the terminal 300-1 transmits an M4 request message to the smart refrigerator 350 according to the Miracast R2 standard. The M4 request message includes a wfd2-video-formats parameter including resolution information on content corresponding to a landscape-type display, and wfd2-video-formats includes a resolution value, for example, a resolution of 1920×1080. Here, a resolution of 1920×1080 may be a predetermined value. Further, the M4 request message includes a portrait-mode parameter indicating to a sink device that content is rotated. When a portrait-mode value is Enabled, a sink device 350 outputs received content 310-2 that is rotated. When the portrait-mode value is None, the sink device 350 outputs the received content 310-2 that is not rotated. Since the content 310-1 output from the terminal 300-1 is set in the portrait mode, the terminal 300-1 transmits the portrait-mode parameter including the value of Enabled to the smart refrigerator 350 so that the smart refrigerator 350 rotates and outputs the content 310-2, converted into resolution corresponding to the landscape orientation according to the Miracast R2 standard. Accordingly, the smart refrigerator 350 rotates and outputs the content 310-2, converted based on the wfd2-video-formats parameter of the M4 request message, according to the value of Enabled of the portrait-mode parameter. That is, the smart refrigerator 250 may rotate and outputs the content 310-2, which corresponds to the landscape-type display by resolution conversion, corresponding to the portrait-type display.

The content 310 set to a resolution of 1080 in width and 1920 in height may be output to a terminal 300-2 having a display set to the landscape type. Here, since the display of the terminal 300-2 is set to the landscape type, content 310-3 output from the terminal 300-2 may have different resolution from that of the content 310. For example, the content 310 is set to a resolution of 1080 in width and 1920 in height, but the content 310-3 output from the terminal 300-2 may be set to a resolution of 1920 in width and 1080 in height. When streaming the content 310-3, the terminal 300-2 transmits an M4 request message in which a wfd2-video-formats parameter includes a resolution of 1920×1080 and a portrait-mode parameter has a value of None. Accordingly, the smart refrigerator 350 outputs content 310-4, which has resolution converted according to the value of the wfd2-video-formats parameter in the M4 request message, without rotating based on the value of None of the portrait-mode parameter.

Content 330 set to a resolution of 1920 in width and 1080 in height may be output to the terminal 300-1 having the portrait-type display. Here, since the display of the terminal 300-1 is set to the portrait type, content 330-1 output from the terminal 300-1 may have different resolution from that of the content 330. For example, the content 330 is set to a resolution of 1920 in width and 1080 in height, but the content 330-1 output from the terminal 300-1 may be set to a resolution of 1080 in width and 1920 in height. The terminal 300-1 converts the resolution of the content 330-1 corresponding to a landscape-type display according to the Miracast R2 standard and transmits the content to the smart refrigerator 350. The terminal 300-1 transmits an M4 request message in which a wfd2-video-formats parameter includes a resolution of 1920×1080 and a portrait-mode parameter has a value of Enabled. Accordingly, the smart refrigerator 350 recognizes the resolution of content 330-2 with reference to the wfd2-video-formats parameter in the M4 request message, and rotates and outputs the content 300-2 based on the value of Enabled of the portrait-mode parameter.

The content 330 set to a resolution of 1920 in width and 1080 in height may be output to the terminal 300-2 having the display set to the landscape type. Here, since the display of the terminal 300-2 is set to the landscape type, content 330-3 output from the terminal 300-2 may be set to a resolution of 1920 in width and 1080 in height, which is the same as that of the content 330. When streaming the content 330-3, the terminal 300-2 transmits an M4 request message in which a wfd2-video-formats parameter includes a resolution of 1920×1080 and a portrait-mode parameter has a value of None. Accordingly, the smart refrigerator 350 outputs content 330-4, which has resolution converted according to the value of the wfd2-video-formats parameter in the M4 request message, without rotating based on the value of None of the portrait-mode parameter.

That is, the smart refrigerator 350 may or may not rotate, based on the value of the portrait-mode parameter in the M4 request message, content having resolution converted corresponding to a landscape-type display according to the Miracast R2 standard, thereby outputting the same content as from the terminal 300-1 or 300-2.

As described above, the smart refrigerator 350 including the portrait-type display, which is a sink device, may output the same content as from the terminal 300-1 or 300-2, which is a source device, using a rotation operation according to the Miracast R2 standard. However, the rotation operation selectively occurs, and the display type of the sink device is not considered for the source device. That is, since the source device cannot know the display type of the sink device until a session is established, the source device cannot support the rotation operation of the sink device. That is, the sink device needs to autonomously perform the content rotation operation.

Although the sink device can report the necessity of the portrait mode to the source device through a wfd2-video-stream-control parameter included in an M21 request message, the transmission of the M21 request message is possible after a session is established between the source device and the sink device. Further, the transmission of the M21 request message is optional and thus is inefficient. Moreover, the M21 request message may not be used. In addition, when the display orientation configuration of the source device is changed during streaming, the source device and the sink device need to renegotiate a capability. Furthermore, since there is no resolution corresponding to a portrait-type display, a portrait-mode parameter is definitely required in order to express resolution corresponding to a portrait-type display.

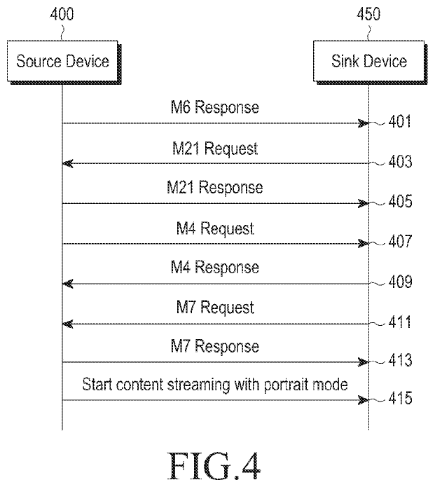

FIG. 4 illustrates a message transmission procedure for providing content to a sink device having a portrait-type display according to a first embodiment of the present disclosure. A procedure before the establishment of an RTSP session between a source device 400 and a sink device 450 is omitted.

Referring to FIG. 4, the source device 400 transmits an M6 response message to the sink device 450, thereby establishing the RTSP session between the source device 400 and the sink device 450 (401). The sink device 450 transmits an M21 request message to the source device 400, thereby reporting to the source device 400 that a display is a portrait type (403). Here, the M21 request message may be a content type request message. The source device 400 transmits an M21 response message to the sink device 450 in response to the M21 request message (405). The M21 response message may be a response message to the content type request. The source device 400 reports portrait-mode=“enabled” to the sink device 450 through a wfd2-video formats parameter in an M4 request message (407). That is, the source device 400 reports to the sink device 450 that content is transmitted corresponding to a portrait-type display. The sink device 450 transmits an M4 response message in response to the M4 request message (409). Also, the sink device 450 reports to the source device 400 that the content is ready to be played back through an M7 request message (411). The source device 400 transmits an M7 response message to the sink device 450 in response to the M7 request message, thereby completing the establishment of the session (413). The source device 400 streams the content in the portrait mode to the sink device 450 (415). Here, the M7 response message may be a message indicating that the content is scheduled to be transmitted. As the source device 400 streams the content in the portrait mode, the sink device 450 may output, on the portrait-type display, the same content as the content output from the source device 400. The content outputted from the sink device 450 is illustrated in FIG. 6.

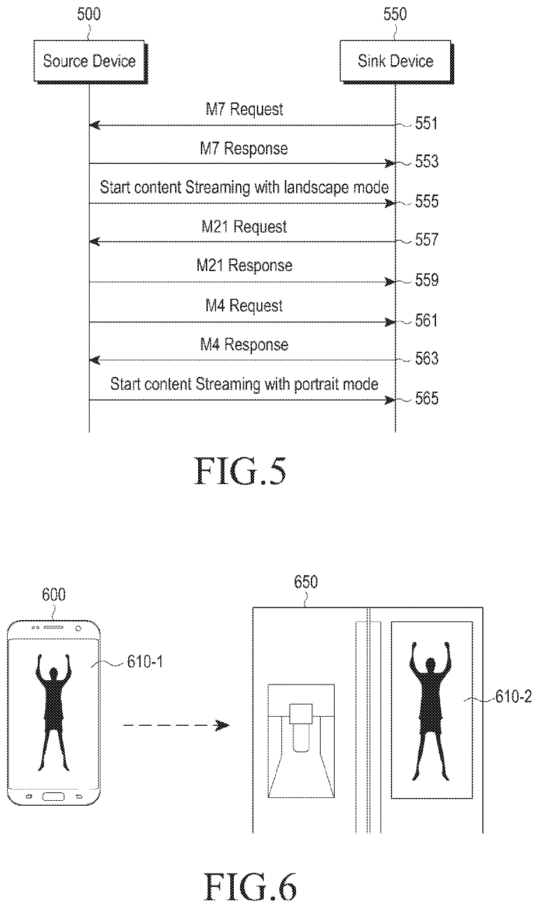

FIG. 5 illustrates a message transmission procedure for providing content to a sink device having a portrait-type display according to a second embodiment of the present disclosure. A procedure before the establishment of an RTSP session between a source device 500 and a sink device 550 is omitted.

Although not shown in FIG. 5, an RTSP session between the source device 500 and the sink device 550 has been established.

Referring to FIG. 5, the sink device 550 reports to the source device 500 that content is ready to be played back through an M7 request message (551). The source device 500 transmits an M7 response message to the sink device 550 in response to the M7 request message (553), and the source device 500 streams the content in the landscape mode to the sink device 550 (555). Here, when the sink device 550 receives wfd2-video-stream-control and wfd2-rotation-capability parameters, the sink device 550 may transmit an M21 request message to the source device 500, instead of outputting the content streamed in the landscape mode, after the session is established. The sink device 550 transmits the M21 request message to report to the source device 500 that the display is set in the portrait mode (557) and receives an M21 response message from the source device 500 in response thereto (559). The source device 500 reports portrait-mode=“enabled” to the sink device 550 through a wfd2-video formats parameter in an M4 request message (561). That is, the source device 500 reports to the sink device 550 that content is transmitted corresponding to a portrait-type display. The sink device 550 transmits an M4 response message in response to the M4 request message (563). Upon receiving the M4 response message, the source device 500 streams the content in the portrait mode (565). The content outputted from the sink device 550 is illustrated in FIG. 6.

FIG. 6 illustrates content output from a display of a sink device according to the first embodiment and the second embodiment of the present disclosure.

Referring to FIG. 6, content 610-1 may be output to a source device 600 having a portrait-type display. Since the source device 600 knows that the sink device 650 prefers a portrait-type display through an M21 request message received from the sink device 650, the source device 600 may stream the content 610-1 in the portrait mode. Here, content 610-2 output from the sink device 650 is the same as the content 610-1 output from the source device 600.

Accordingly, the sink device 650 may output, on the portrait-type display, the content 610-2 in the same form as that of the content 610-1 output from the source device 600.

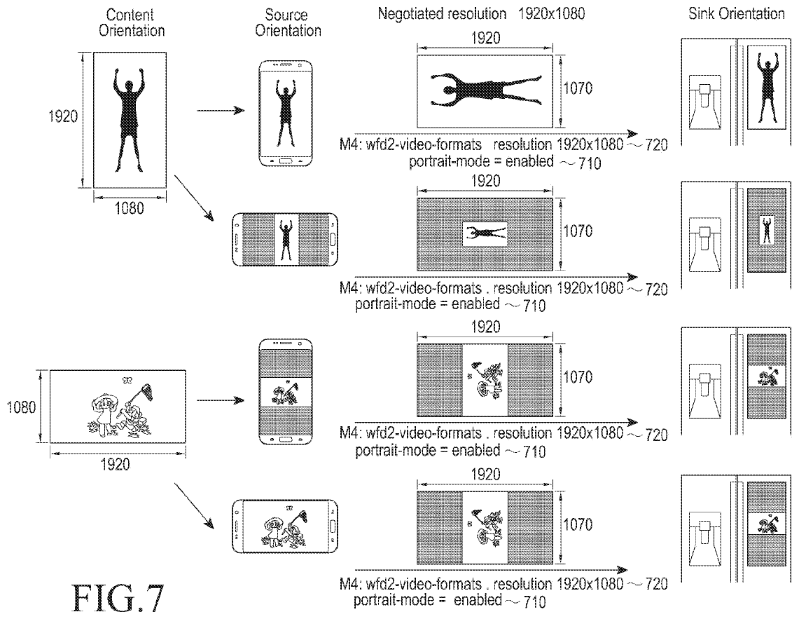

FIG. 7 illustrates a mode of transmitting content to a sink device having a portrait-type display according to a third embodiment of the present disclosure.

Referring to FIG. 7, a terminal may stream content corresponding to a portrait-type display of a smart refrigerator. Here, the terminal may include the value of Enabled 710 in a portrait-mode parameter of an M4 request message, thereby reporting to the smart refrigerator that the terminal streams the content corresponding to the portrait-type display. Additionally, the M4 request message includes a resolution of 1920×1080 720, which is a resolution value corresponding to a landscape-type display, in a wfd2-video formats parameter.

The smart refrigerator transmits, to the terminal, information indicating that the display is set in the portrait mode so that the terminal may stream content corresponding to the portrait-type display. Accordingly, the terminal can recognize the display type of the smart refrigerator. Upon recognizing that the display of the smart refrigerator is set in the portrait mode, the terminal transmits the M4 message including the value of Enabled in the portrait-mode parameter, thereby reporting to the smart refrigerator that the content is transmitted in the portrait mode. That is, unlike in a conventional case where content is transmitted either in the landscape mode or in the portrait mode depending on whether the display of a terminal is set in the landscape orientation or the portrait orientation, the terminal may transmit the content in the portrait mode considering that the display of the smart refrigerator is set in the portrait mode.

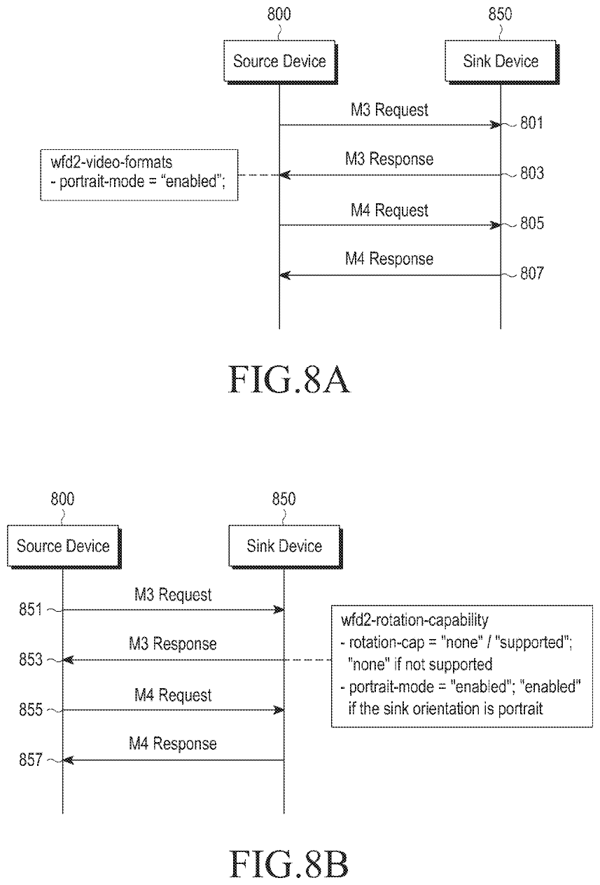

FIG. 8A illustrates a message transmission procedure for providing content to a sink device having a portrait-type display according to option 1 of the third embodiment of the present disclosure. A procedure before the transmission of an M3 request message from the source device 800 to the sink device 850 is omitted.

Referring to FIG. 8A, the source device 800 transmits the M3 request message to the sink device 850, thereby reporting the capabilities of the source device 800, such as content support information or the like, to the sink device 850 (801). The sink device 850 transmits an M3 response message in response, thereby reporting the capabilities of the sink device 850, such as content support information or the like, to the source device 800 (803). The M3 request message may be a message carrying capability information on a display set in the source device. Further, the M3 response message may be a message carrying capability information on a display set in the sink device.

Here, the sink device 850 may add a portrait-mode value to a wfd2-video-formats parameter included in the M3 response message. That is, the sink device 850 may report to the source device 800 that the display of the sink device 850 is set in the portrait mode through the portrait-mode value included in the wfd2-video-formats parameter of the M3 response message. Therefore, when the display of the sink device 850 is set in the portrait mode, the portrait-mode value in the wfd2-video-formats parameter of the M3 response message is Enabled.

The source device 800 transmits an M4 request message to report to the sink device 850 that content is transmitted in the portrait mode based on the portrait-mode value of the received M3 response message (805). In response, the sink device 850 transmits an M4 response message to the source device 800 (807).

In a conventional case, the source device 800 transmits an M4 request message including a portrait-mode value in a wfd2-video-formats parameter to the sink device 850 to thereby report to the sink device 850 whether content is in the portrait mode or in the landscape mode, and the sink device 850 rotate or does not rotate the content based on the portrait-mode value received through the M4 request message 805. For example, when the portrait-mode value received through the M4 request message is Enabled, the sink device 850 rotates content streamed from the source device 800. When the portrait-mode value is None, the sink device 850 does not rotate the streamed content. That is, in the conventional case, the sink device 850 modifies streamed content corresponding to the portrait-type display. In the third embodiment of the present disclosure, however, the sink device 850 reports to the source device 800 that the display is set in the portrait mode through the M3 message before content is streamed, so that the source device 800 may stream content in the portrait mode.

FIG. 8B illustrates a message transmission procedure for providing content to a sink device having a portrait-type display according to option 2 of the third embodiment of the present disclosure. A procedure before the transmission of an M3 request message from the source device 800 to the sink device 850 is omitted.

Referring to FIG. 8B, the source device 800 transmits the M3 request message to the sink device 850, thereby reporting the capabilities of the source device 800, such as content support information or the like, to the sink device 850 (851). The sink device 850 transmits an M3 response message in response, thereby reporting the capabilities of the sink device 850, such as content support information or the like, to the source device 800 (853).

Here, the sink device 850 may add a portrait-mode value to a wfd2-rotation-capability parameter, which already includes a rotation-cap value, in the M3 response message, thereby reporting to the source device 800 that a display of the sink device 850 is set in the portrait mode. Here, the rotation-cap value indicates whether a content rotation function is supported. When the rotation-cap value is “None”, the content rotation function is not supported. When the rotation-cap value is “Supported”, the content rotation function is supported.

The source device 800 transmits an M4 request message to report to the sink device 850 that content is transmitted in the portrait mode based on the portrait-mode value of the received M3 response message (855). In response, the sink device 850 transmits an M4 response message to the source device 800 (857).

Accordingly, the sink device 850 transmits the M3 response message further including the portrait-mode value in the wfd2-rotation-capability parameter to the source device 800, so that the source device 800 can stream content in the portrait mode. The sink device 850, which rotates and outputs content based on a mode for content streamed from the source device 800, for example, the landscape mode or the portrait mode, receives content set in the portrait mode unlike in a conventional case, thereby outputting streamed content in the same form as that of content output from a terminal without rotating the content.

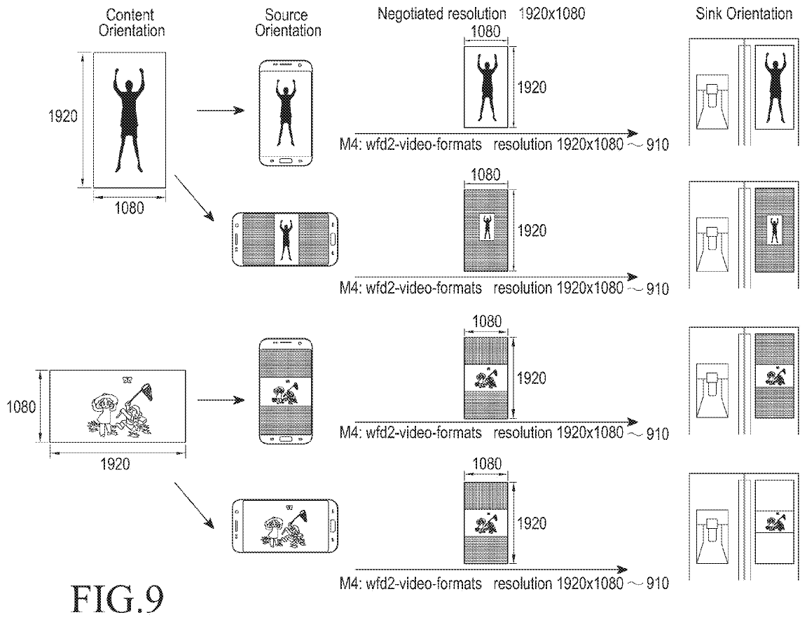

FIG. 9 illustrates a mode of transmitting content to a sink device having a portrait-type display according to a fourth embodiment of the present disclosure.

Referring to FIG. 9, a terminal transmits an M4 request message including a resolution value of 1080×1920 (910) in a wfd2-video formats parameter to a smart refrigeration, so that the smart refrigeration can output content having resolution converted based on the resolution value of 1080×1920 (910). Here, the resolution value of 1080×1920 (910) is a resolution value for a portrait-type display.

Conventionally, only resolution for a landscape-type display, for example, a resolution value of 1920×1080, is supported according to the Miracast R1 standard. Thus, even though a terminal transmits content corresponding to a portrait-type display, a smart refrigerator outputs content that is converted to have resolution corresponding to a landscape-type display, so that the content output from the terminal is different from the content output from the smart refrigerator. The fourth embodiment of the present disclosure support resolution for a portrait-type display, thereby preventing the smart refrigerator from outputting content different from content output from the terminal.

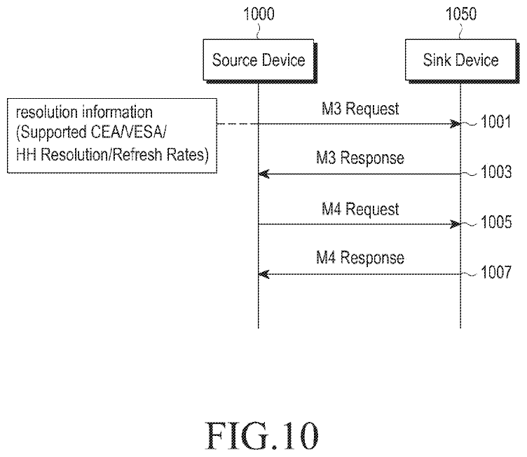

FIG. 10 illustrates a message transmission procedure for providing content to a sink device having a portrait-type display according to a fourth embodiment of the present disclosure. A procedure before the transmission of an M3 request message from the source device 1000 to the sink device 1050 is omitted.

Referring to FIG. 10, the source device 1000 transmits an M3 request message to a sink device 1050 (1001). Here, the source device 1000 transmits the M3 request message including supportable resolution information, for example, CEA/VESA/HH Resolution/Refresh Rates.

The sink device 1050 transmits available resolution information among the resolution information received from the source device 100 via an M3 response message (1003). For example, the sink device 1050 may select resolution corresponding to a portrait-type display from the resolution information transmitted from the source device 1000, include the resolution in the M3 response message, and may transmit the M3 response message to the source device 1000.

The source device 1000 transmits an M4 request message to report to the sink device 1050 that content is transmitted based on the available resolution information received from the sink device 1050 (1005). In response, the sink device 1050 transmits an M4 response message to the source device 1000 (1007).

Accordingly, the sink device 1050 transmits, to the source device 1000, the M3 response message including the available resolution information, that is, the resolution corresponding to the portrait-type display, among the resolution information transmitted by the source device 1000 through the M3 request message, so that the source device 1000 can stream content having the resolution corresponding to the portrait-type display. Therefore, unlike in a conventional case of receiving only content having resolution corresponding to a landscape-type display, the sink device 1050 may receive the content having the resolution corresponding to the portrait-type display, thus outputting the content corresponding to the portrait-type display without rotating the content.

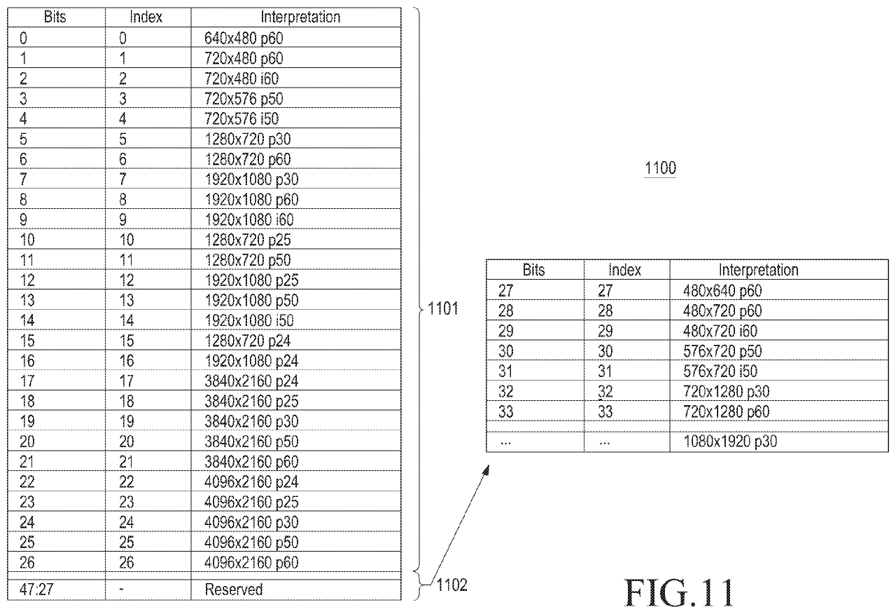

FIG. 11 illustrates a table of resolution parameters according to the fourth embodiment of the present disclosure.

Referring to FIG. 11, resolution information 1102 corresponding to a portrait-orientation display may be added to a resolution table 1100 including resolution information 1102 corresponding to a landscape-orientation display. Here, the resolution information 1101 corresponding to the landscape-orientation display refers to a resolution parameter defined in the Miracast R1 standard. The resolution information 1102 corresponding to the portrait-orientation display refers to a parameter in which the horizontal and vertical resolutions of a resolution parameter defined in the Miracast R1 standard are switched with each other. The resolution parameter is included in an M3 request message. The resolution parameter included in the M3 request message is illustrated in FIG. 10.

As such, the resolution information 1100 includes not only the resolution information 1101 corresponding to the landscape-orientation display but also the resolution information 1102 corresponding to the portrait-orientation display, thereby providing content corresponding to a portrait-type display.

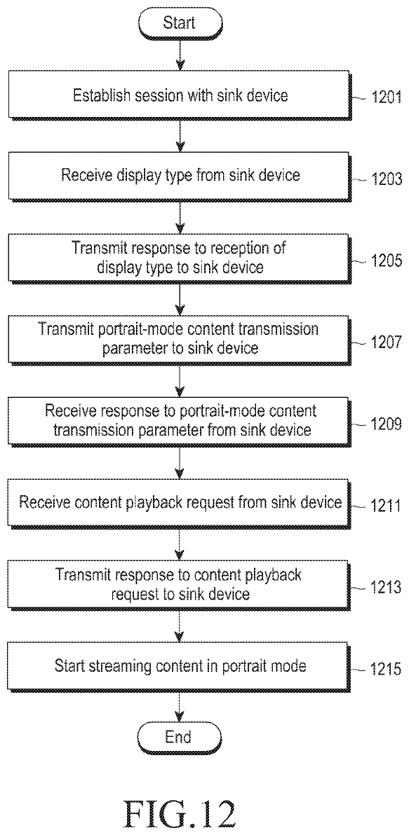

FIG. 12 illustrates a method for transmitting content to a sink device having a portrait-type display according to the first embodiment of the present disclosure.

Although not shown in FIG. 12, a source device and the sink device are connected via Wi-Fi Direct or TDLS.

Referring to FIG. 12, in operation 1201, the source device establishes an RTSP session with the sink device. Specifically, the source device transmits an RTSP setup request to the sink device via an M6 request message and receives an M6 response message from the sink device in response to the RTSP setup request, thereby establishing the RTSP session.

In operation 1203, the source device receives a display type from the sink device. Specifically, the source device receives, via an M21 request message, information indicating that the sink device includes a portrait-type display.

In operation 1205, the source device transmits a response to the reception of the display type to the sink device. Specifically, the source device transmits an M21 response message to the sink device to report that the source device has received the display type.

In operation 1207, the source device reports a portrait-mode content transmission parameter to the sink device. Specifically, the source device transmits an M4 request message including a portrait-mode parameter having the value of Enabled to the sink device.

In operation 1209, the source device receives a response to the portrait-mode content transmission parameter from the sink device. Here, the source device receives the response from the sink device via an M4 response message.

In operation 1211, the source device receives a content playback request from the sink device. Here, the source device receives the content playback request through an M7 request message.

In operation 1213, the source device transmits a response to the content playback request to the sink device. Specifically, the source device transmits the response to the content playback request to the sink device through an M7 response message.

In operation 1215, the source device starts streaming content in the portrait mode. Since the source device recognizes through the M21 request message that the sink device has the portrait-type display, the source device can start the content streaming in the portrait mode.

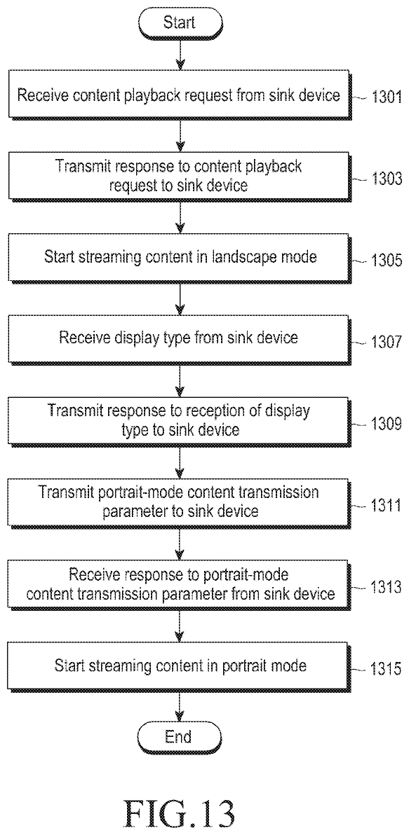

FIG. 13 illustrates a method for transmitting content to a sink device having a portrait-type display according to the second embodiment of the present disclosure.

Although not shown in FIG. 13, a source device and the sink device are connected via Wi-Fi Direct or TDLS.

Referring to FIG. 13, in operation 1301, the source device receives a content playback request from the sink device. Here, the source device receives the content playback request through an M7 request message.

In operation 1303, the source device transmits a response to the content playback request to the sink device. Specifically, the source device transmits the response to the content playback request to the sink device through an M7 response message.

In operation 1305, the source device starts streaming content in the landscape mode. Specifically, the source device streams the content in the landscape mode according to the Miracast R1 standard. Here, the sink device includes a portrait-type display, whereas the content is streamed in the landscape mode. Thus, the sink device does not play back the streamed content. That is, when the content is streamed in the landscape mode, the sink device may not play back the content depending on a predetermined value.

In operation 1307, the source device receives the display type from the sink device. Specifically, the source device receives, via an M21 request message, information indicating that the sink device includes the portrait-type display.

In operation 1309, the source device transmits a response to the reception of the display type to the sink device. Specifically, the source device transmits an M21 response message to the sink device to report that the source device has received the display type.

In operation 1311, the source device reports a portrait-mode content transmission parameter to the sink device. Specifically, the source device transmits an M4 request message including a portrait-mode parameter having the value of Enabled to the sink device.

In operation 1313, the source device receives a response to the portrait-mode content transmission parameter from the sink device. Here, the source device receives the response from the sink device via an M4 response message.

In operation 1315, the source device starts streaming content in the portrait mode. Since the source device recognizes through the M21 request message that the sink device has the portrait-type display, the source device can start the content streaming in the portrait mode.

Accordingly, as the source device streams content in the portrait mode, the sink device can play back the content corresponding to the portrait-type display.

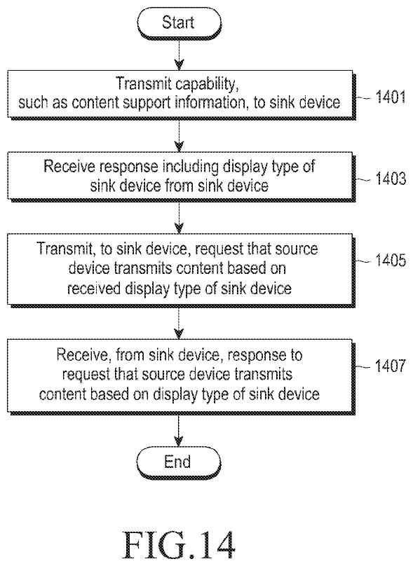

FIG. 14 illustrates a method for transmitting content to a sink device having a portrait-type display according to the third embodiment of the present disclosure.

Referring to FIG. 14, in operation 1401, a source device reports a capability, such as content support information, to the sink device. Specifically, the source device reports the capability, such as content support information, to the sink device through an M3 request message.

In operation 1403, the source device receives a response including the display type of the sink device from the sink device. Specifically, the source device receives an M3 response message including a portrait-mode value in a wfd2-video-formats parameter.

In operation 1405, the source device transmits, to the sink device, a request that the source device transmits content based on the display type of the sink device. Specifically, the source device reports through an M4 request message that content is transmitted to the sink device in the portrait mode based on the portrait-mode value in the received M3 response message.

In operation 1407, the source device receives, from the sink device, a response to the request that the source device transmits content based on the display type of the sink device. Specifically, the source device receives an M4 response message in response to the M4 request message.

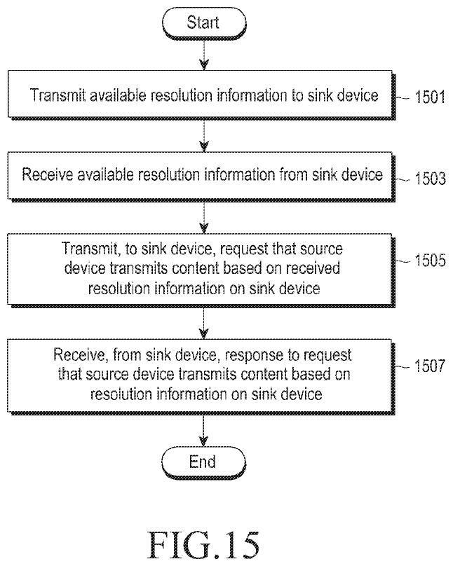

FIG. 15 illustrates a method for transmitting content to a sink device having a portrait-type display according to the fourth embodiment of the present disclosure.

Referring to FIG. 15, in operation 1501, a source device transmits available resolution information to the sink device. Specifically, the source device transmits an M3 request message including supportable resolution information to the sink device.

In operation 1503, the source device receives available resolution information from the sink device. Specifically, the source device receives, through an M3 response message, resolution corresponding to a portrait-type display selected from the available resolution information transmitted by the source device.

In operation 1505, the source device transmits, to the sink device, a request that the source device transmits content based on the received resolution information on the sink device. Specifically, the source device reports through an M4 request message that content is transmitted to the sink device based on the resolution information in the received M3 response message.

In operation 1507, the source device receives, from the sink device, a response to the request that the source device transmits content based on the resolution information on the sink device. Specifically, the source device receives an M4 response message in response to the M4 request message.

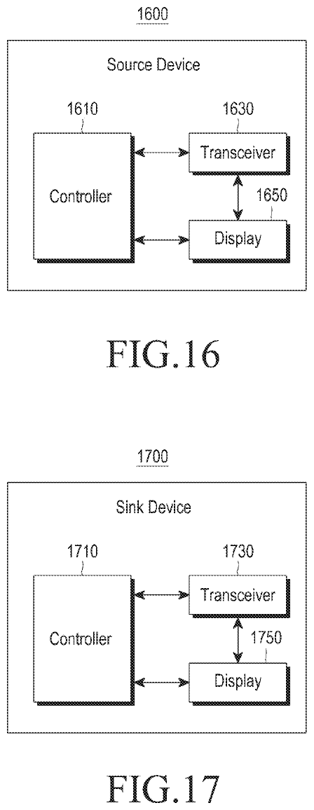

FIG. 16 illustrates the configuration of a source device according to one embodiment of the present disclosure. For the convenience of description, components not directly relevant to the present disclosure are not shown, and a description thereof is omitted herein.

Referring to FIG. 16, the source device 1600 includes a controller 1610, a transceiver 1630, and a display 1650.

The controller 1610 controls the transceiver 1630 and the display 1650.

The transceiver 1630 receives a display type from a sink device, transmits a response to the reception of the display type, and transmits content based on the display type.

The display 1650 outputs content according to the display type of the source device 1600. For example, when a display of the source device 1600 is set in the landscape orientation, the source device 1600 outputs content in the landscape mode. When the display is set in the portrait orientation, the source device 1600 outputs content in the portrait mode.

FIG. 17 illustrates the configuration of a sink device according to one embodiment of the present disclosure. For the convenience of description, components not directly relevant to the present disclosure are not shown, and a description thereof is omitted herein.

Referring to FIG. 17, the sink device 1700 includes a controller 1710, a transceiver 1730, and a display 1750.

The controller 1710 controls the transceiver 1730 and the display 1750.

The transceiver 1730 transmits a display type to a source device, receives a response to the transmission of the display type, and receives content based on the display type.

The display 1750 outputs the received content based on the display type. Here, the display 1750 may be a portrait-type display.

Particular aspects of the present disclosure may be implemented as a computer-readable code in a computer-readable recording medium. The computer-readable recording medium is a predetermined data storage device which can store data which can be read by a computer system. Examples of the computer readable recording medium may include a read-only memory (ROM), a random access memory (RAM), a CD-ROM, a magnetic tape, a floppy disk, an optical data storage device, and a carrier wave (such as data transmission through the Internet). The computer-readable recording medium may be distributed through computer systems connected to the network, and accordingly the computer-readable code is stored and executed in a distributed manner. Further, functional programs, codes and code segments for achieving the present disclosure may be easily interpreted by programmers skilled in the art which the present disclosure pertains to.

It will be understood that a method and apparatus according to an embodiment of the present disclosure may be implemented in the form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be appreciated that the method according to various embodiments of the present disclosure may be implemented by a computer or portable terminal including a controller and a memory, wherein the memory is one example of machine-readable storage media suitable to store a program or programs including instructions for implementing the embodiments of the present disclosure.

Accordingly, the present disclosure includes a program for a code implementing the apparatus and method described in the appended claims of the specification and a machine (a computer or the like)-readable storage medium for storing the program. Further, the program may be electronically carried by any medium such as a communication signal transferred through a wired or wireless connection, and the present disclosure appropriately includes equivalents thereof.

Further, an apparatus according to various embodiments of the present disclosure may receive the program from a program providing device that is wiredly or wirelessly connected thereto, and may store the program. The program providing device may include a program including instructions through which a program processing device performs a preset content protecting method, a memory for storing information and the like required for the content protecting method, a communication unit for performing wired or wireless communication with the program processing device, and a controller for transmitting the corresponding program to a transceiver at the request of the program processing device or automatically.

Meanwhile, the exemplary embodiments disclosed in the specification and drawings are merely presented to easily describe technical contents of the present disclosure and help the understanding of the present disclosure and are not intended to limit the scope of the present disclosure. Further, the embodiments of the present disclosure as described above are merely illustrative, and it will be understood by those skilled in the art that various modifications and equivalents thereof are possible within the scope of the present disclosure. Therefore, the true technical scope of protection of the present disclosure should be defined by the following appended claims.

Particular aspects of the present disclosure may be implemented as a computer-readable code in a computer-readable recording medium. The computer-readable recording medium may be any data storage device which can store data readable by a computer system. Examples of the computer readable recording medium may include a read-only memory (ROM), a random access memory (RAM), a CD-ROM, a magnetic tape, a floppy disk, an optical data storage device, and a carrier wave (such as data transmission through the Internet). The computer-readable recording medium may be distributed through computer systems connected to the network, and accordingly the computer-readable code is stored and executed in a distributed manner. Further, functional programs, codes and code segments for achieving the present disclosure may be easily interpreted by programmers skilled in the art which the present disclosure pertains to.

It will be understood that a method and apparatus according to an embodiment of the present disclosure may be implemented in the form of hardware, software, or a combination of hardware and software. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be appreciated that the method according to various embodiments of the present disclosure may be implemented by a computer or portable terminal including a controller and a memory, wherein the memory is one example of machine-readable storage media suitable to store a program or programs including instructions for implementing the embodiments of the present disclosure.

Accordingly, the present disclosure includes a program for a code implementing the apparatus and method described in the appended claims of the specification and a machine (a computer or the like)-readable storage medium for storing the program. Further, the program may be electronically carried by any medium such as a communication signal transferred through a wired or wireless connection, and the present disclosure appropriately includes equivalents thereof.

Further, an apparatus according to various embodiments of the present disclosure may receive the program from a program providing device that is wiredly or wirelessly connected thereto, and may store the program. The program providing device may include a program including instructions through which a program processing device performs a preset content protecting method, a memory for storing information and the like required for the content protecting method, a communication unit for performing wired or wireless communication with the program processing device, and a controller for transmitting the corresponding program to a transceiver at the request of the program processing device or automatically.

Meanwhile, the exemplary embodiments disclosed in the specification and drawings are merely presented to easily describe technical contents of the present disclosure and help the understanding of the present disclosure and are not intended to limit the scope of the present disclosure. Further, the embodiments of the present disclosure as described above are merely illustrative, and it will be understood by those skilled in the art that various modifications and equivalents thereof are possible within the scope of the present disclosure. Therefore, the true technical scope of protection of the present disclosure should be defined by the following appended claims.

1. A method for transmitting, by a source device, content to a sink device, the method comprising:
receiving a display type from the sink device;
generating content in view of the display type; and
transmitting the generated content to the sink device,
wherein the display type comprises information indicating a set type of a display of the sink device.

2. The method of claim 1, further comprising establishing a Real-Time Streaming Protocol (RTSP) session with the sink device before receiving the display type.

3. The method of claim 1, further comprising negotiating a start of transmission of the content after receiving the display type.

4. The method of claim 1, wherein the transmitting of the content further comprises transmitting the content corresponding to a portrait mode when the display of the sink device is set in a portrait form.

5. The method of claim 1, further comprising transmitting, to the sink device, a message indicating that the content is scheduled to be transmitted based on the display type.

6. The method of claim 1, wherein the display type is received through at least one of a content form request message and a message carrying capability information on the display set in the sink device.

7. A method for receiving, by a sink device, content from a source device, the method comprising:
transmitting a display type to the source device;
receiving content in view of the display type from the source device; and
outputting the content through a display,
wherein the display type comprises information indicating a set type of the display of the sink device.

8. The method of claim 7, wherein the receiving of the content in view of the display type is receiving the content corresponding to a portrait mode when the display of the sink device is set in a portrait form.

9. The method of claim 7, further comprising receiving, from the source device, a message indicating that the content is scheduled to be transmitted based on the display type.

10. The method of claim 7, wherein the display type is transmitted through at least one of a content form request message and a message carrying capability information on the display set in the sink device.

11. The method of claim 7, further comprising receiving the content in a landscape mode from the source device before transmitting the display type,
wherein when the display type of the sink device is a portrait type and the content is in a landscape mode, the content is not played back.

12. A source device for transmitting content to a sink device, the source device comprising:
a transceiver that receives a display type from the sink device and transmits content to the sink device; and
a processor that generates content in view of the display type and controls the transceiver to transmit the generated content to the sink device,
wherein the display type comprises information indicating a set type of a display of the sink device.

13. The source device of claim 12, wherein the transceiver transmits the content corresponding to a portrait mode when the display of the sink device is set in a portrait form.

14. A sink device for receiving content from a source device, the sink device comprising:
a display;
a transceiver that transmits a display type to the source device and receives content in view of the display type from the source device; and
a processor that controls the display to output the content,
wherein the display type comprises information indicating a set type of a display of the sink device.

15. The method of claim 14, wherein the transceiver receives the content in a landscape mode from the source device before transmitting the display type, and
when the display type of the sink device is a portrait type and the content is in a landscape mode, the content is not played back.
